(19) United States
(12) Patent Application Publication
(10) Pub. No.: US 2024/0171563 A1
(43) Pub. Date: May 23, 2024

(54) USING A TOFU (TRUST ON FIRST USE) SCHEME TO PROVIDE A SECURE INTERFACE BETWEEN TWO MODULES

(71) Applicant: Intel Corporation, Santa Clara, CA (US)

(72) Inventors: Yoni Kahana, Kfar Hess (IL); Eytan Mann, Modiin (IL)

(21) Appl. No.: 18/057,303

(22) Filed: Nov. 21, 2022

(51) Int. Cl. H04L 9/40

(52) U.S. Cl. CPC H04L 63/0823; H04L 63/0435

(57) ABSTRACT

An architecture is provided that enables a trust on first use (TOFU) scheme to be realized for two modules (such as an SoC and a companion module) that comprise part of a hardware platform. The architecture leverages symmetric encryption schemes and relies upon an initial setup process in a controlled environment, during which time unencrypted communications may initially be used until the SoC and companion module each store a security key that is generated by the SoC. The key may be a bit string that is generated via a random number generator, thereby obviating the need to utilize hardware secure module (HSM) provisioning and complex encryption hardware. Moreover, the disclosure is directed to supporting additional phases of the manufacturing process, such as debugging and a restoration process that functions to delete or invalidate the keys stored in the SoC and companion module.

### TECHNICAL FIELD

The disclosure described herein generally relates to providing secure interfaces between modules and, more particularly, to the use of a Trust on First Use (TOFU) scheme to provide interface encryption while avoiding production key provisioning.

### BACKGROUND

The continued demand for additional connectivity in consumer electronic devices such as laptops has driven the demand for expansion cards. Such expansion cards may be referred to as modules, and may support additional wired or wireless connectivity, which may include Bluetooth, Wi-Fi, etc. Such expansion modules typically have a standardized form factor and connect to the electronic device via a dedicated and/or standard hardware slot interface, such as the M.2 form factor. The electronic device may also include a system on a chip (SoC) that includes a central processing unit (CPU), as well as other processing circuitry that communicates with the expansion module via a data interface. The SoC may also be referred to as a module.

The operations that occur between the SoC and the expansion card may include the exchange of data that is transmitted and received from the electronic device, as well as secure registers and/or data stored in the modules. Therefore, the data interface may be a target of malicious attacks, and it is thus preferable that the data interface be secured or that other measures be implemented. Such secure interfaces may be realized via the use of encryption or other means. However, the conventional means of providing a secure interface using encryption has been costly and complex, and may not be adequate for more advanced attacks. As a result, current solutions to provide a secure interface between modules have been inadequate.

### BRIEF DESCRIPTION OF THE DRAWINGS/FIGURES

The accompanying drawings, which are incorporated herein and form a part of the specification, illustrate the present disclosure and, together with the description, further serve to explain the principles and to enable a person skilled in the pertinent art to make and use the implementations as discussed herein.

FIG. 1 illustrates a block diagram of an architecture supporting data communications between two modules, in accordance with the disclosure;

FIG. 2A illustrates a first power up Trust on First Use (TOFU) process flow, in accordance with the disclosure;

FIG. 2B illustrates a power up operational process flow, in accordance with the disclosure;

FIG. 3A illustrates a debug power up process flow in which a key is initially provided, in accordance with the disclosure;

FIG. 3B illustrates a subsequent debug power up process flow using the previously-provided key, in accordance with the disclosure;

FIG. 4 illustrates an open state restoration process flow to restore the modules to an open state, in accordance with the disclosure; and

FIG. 5 illustrates an electronic device, in accordance with the disclosure.

The present disclosure will be described with reference to the accompanying drawings. The drawing in which an element first appears is typically indicated by the leftmost digit(s) in the corresponding reference number.

### DETAILED DESCRIPTION

In the following description, numerous specific details are set forth in order to provide a thorough understanding of the present disclosure. However, it will be apparent to those skilled in the art that the implementations of the disclosure, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring the disclosure.

### I. Technology Overview

Again, expansion modules provide additional support for wired or wireless connectivity, which may include Bluetooth, Wi-Fi, etc. Recent developments in the SoC used for electronic devices facilitate offloading of different levels of connectivity solutions based upon the particular platform and application. In other words, key elements of a wireless radio access technology (RAT) may alternatively be moved from the expansion module, which may alternatively be referred to herein as a companion module, to the SoC implemented in the electronic device. Such solutions may be referred to as “connectivity integration,” and function by leveraging a SoC that has been specifically configured for this purpose.

That is, and as further discussed herein, the SoC may comprise a controller chipset, a central processing unit (CPU), also referred to herein as simply a processing unit, and dedicated connection control circuitry. The SoC may be configured such that the network adapter and/or other components of the companion module, which may include large and usually expensive functional blocks (MAC components, memory, processor and associated logic/firmware) are moved inside the SoC. Thus, the companion module may be manufactured using a smaller subset of functional blocks compared to those that would typically be required, which may include a signal processor, analog and Radio frequency (RF) functions, etc. Therefore, connectivity integration requires an accompanying chipset and CPU support provided by the SoC. By offloading the functional blocks typically identified with the companion module in this way, the companion modules may be simplified and manufactured for a lower cost.

To support this functionality, the data interface between the SoC and the companion module typically supports a relatively medium to low speed interface for control (generally <1 Gbits/sec raw speed). This data interface is used by the SoC module to apply controls and to read status data from the companion module. Data transmitted over the data interface is also used to apply direct control to various low level registers. Such controls may include setting the synthesizer frequency for TX and RX, setting the transmitter output power, activating the transmitter just in time, reading dynamic changing status both for monitoring as well as for debugging, etc. Furthermore, in many cases the status read from the companion module is used to directly “feed” state machines, as well as to control plane real time firmware (FW).

Thus, the integrity, timing, and coherency of these controls/status are critical to the performance of the companion module, and may impact regulatory requirements. As one non-limiting and illustrative scenario, the SoC may transfer data via the data interface to set the transmitter output power to an incorrect value, resulting in a violation of the regulatory standard and risk violation of the specific absorption rate (SAR) specification. As another non-limiting and illustrative scenario, the SoC may transfer data via the data interface to set the frequency of the companion module synthesizer incorrectly, resulting in the corruption of communications associated with another operating channel. Moreover, altering status data of the companion module may result in the Wi-Fi functioning erratically, which may lead to unpredictable behavior.

Thus, the data interface may become a security risk, i.e. considered to be vulnerable to a hardware (HW) adversary, whom may aim to compromise the integrity and authenticity of the data interface to compromise the confidentiality of the payload and/or alter control inputs. Further, such an attacker may attempt to violate a regulatory requirement and/or standard, or activate the RF control in a way that is incompatible or unsuitable for the companion module. Alternatively, such attacks may provide a status output that may create undesired behavior of the SoC, and as a result become a vulnerable security bridge into the platform. In one illustrative and non-limiting scenario, an adversary that can manipulate the content of the payload on the data interface may re-program control units on both sides (i.e. the SoC and the companion module), change the state machine, sniff the internal registers (including any security keys), and eavesdrop confidential information/payloads that are not encrypted between the SoC and the companion module. Thus, the integrity of the data transferred over the data interface needs to be protected against malicious attacks. However, implementing conventional encryption measures requires a relatively complex and large silicon infrastructure.

Furthermore, conventional solutions directed to protecting data communications generally include the use of a Server-Client TOFU, but require a significant amount of processing power to enable the client side to establish trust with the server based on a public key or, in case of lack of public key, based on a user decision. However, such models cannot be applied in the case of HW interfaces because, among other reasons, there is no option for a user decision to be provided, as the data interface between the companion module and the SoC requires very low level processing to avoid cost and silicon. Moreover, such implementations likewise cannot leverage public keys (PK), since both sides do not have a hardware secure module to store a private key (which would increase costs significantly).

Such conventional server/client data protection mechanisms may also protect data commutations by including PK engines with random number generators. However, such solutions cannot be adapted to HW interfaces, as doing so would require adding random number generators and PK engines to both sides, prohibitively increasing the cost of the product. Furthermore, a PK solution requires private key, which is required to be secured properly, unlike in the server/client model. Thus, for a HW interface this requires an additional hardware secure module to store the private key, which again increases the cost of the SoC and companion module.

Another conventional solution for protecting data communications includes the use of a high-speed interface. By increasing the speed of data transfers, the security risk is reduced, as noted above. However, in many cases it is challenging to implement high speed data transfers due to the nature of the high speed interface that requires a calibration data flow. Also, such solutions are relatively short-sighted, as with technology improvements what is considered today as a high speed interface that is not vulnerable to an adversary may become vulnerable in the future.

Yet another conventional solution for protecting data communications includes encrypting the interface with a shared key. Such encryption is a good method to address a HW adversary since it provides logical, cryptographic protection. However, this requires a mechanism to have a shared key between the two sides of the data interface to be used for the encryption, which raises a significant challenge regarding how to provision the shared key in production. To this end, it is noted that the key provisioning process during production is a common method that requires changing production processes by adding a hardware secure module (HSM). This adaptation incurs significant costs, changes in the maintenance process, adding secure zones, and production workers that leak or mishandle the keys can comprise the solution. Therefore, due to such implications, in many cases it is preferred to avoid the use of HSM altogether.

To address these issues, the disclosure is directed to an architecture that enables a trust on first use (TOFU) scheme that is realized for (at least) two modules that may comprise part of any suitable hardware platform. As further discussed herein, these modules may comprise the aforementioned SoC and a companion module, which may be an expansion card. The architecture as further discussed herein leverages symmetric encryption schemes and relies upon an initial setup process in a controlled environment, during which time unencrypted communications may initially be used until the SoC and companion module each store a security key (alternatively referred to herein simply as a “key”), which is generated by the SoC. After this initial power up procedure has completed in a controlled environment, subsequent operation of the system may utilize symmetric encryption using the generated key, which is stored internally in non-volatile memory. The key may be a bit string that is generated via a random number generator or other suitable means, thereby obviating the need to utilize HSM provisioning and complex encryption hardware.

Moreover, the disclosure is also directed to supporting additional phases of the manufacturing process, debugging, as well as a restoration process that functions to delete the keys from the SoC and the companion module. For the debugging process, a signed image is written to a portion of the SoC memory and executed in a controlled environment. The signed image contains a hardware platform identifier (unique to a platform that cannot be altered) that the SoC may utilize to verify compatibility once the image has been authenticated, as well as one or more preexisting keys that may be written to the SoC and the companion module to facilitate debugging using encrypted communications.

For the restoration process, an electronic device identified with the hardware platform (i.e. the SoC, companion module, and other components) communicates with a trusted certificate authority (CA) server. The electronic device executes a local host software program, which results in the request for a random number to be generated via the companion module. This request may be relayed or forwarded to the companion module via the SoC, which directly communicates with the local host software. The random number may then be provided to the host software program, which transmits the random number to the CA server and, in response, receives a signed request to perform the restoration process that includes the generated random number. The signed request may be authenticated and the random number used as an additional security measure to validate the request. Upon authentication and validation of the signed request, the stored keys in the SoC and the companion module may be deleted or invalidated. Once this process has been completed, the SoC and companion module may be considered in an “open” state, i.e. in the same state prior to the initial setup process as noted above. That is, once the restoration process is completed, an initial power up process may be executed during which time unencrypted communications may initially be used until the SoC and companion module each store a security key, which is subsequently used for encrypted communications.

### II. General Data Interface and Module Architecture

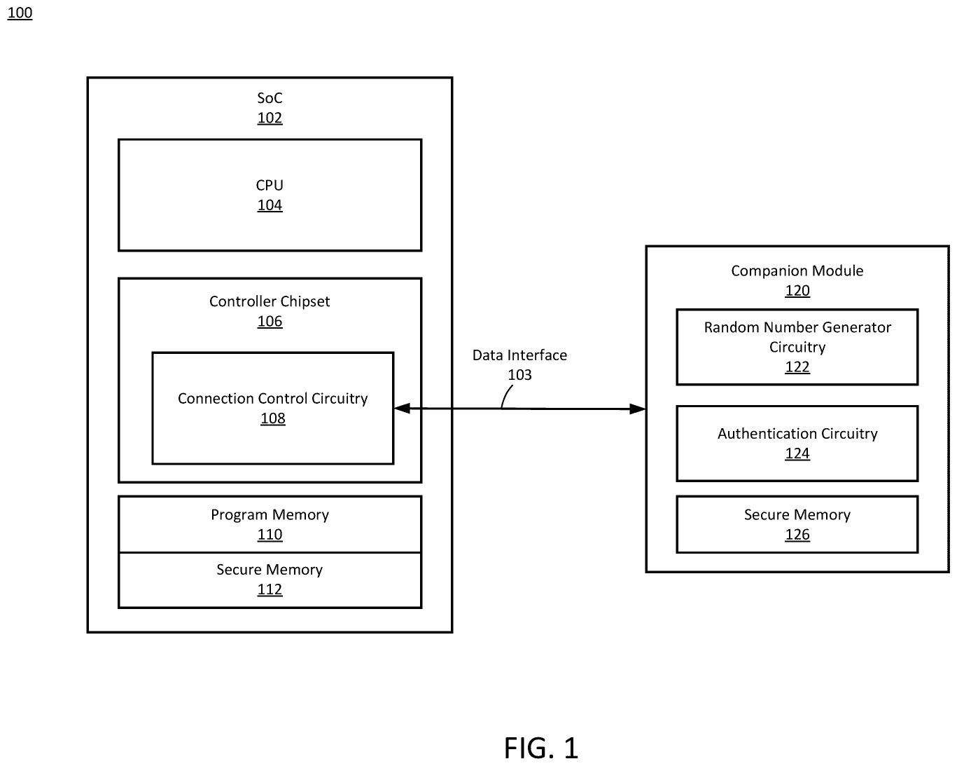

FIG. 1 illustrates a block diagram of an architecture supporting data communications between two modules, in accordance with the disclosure. As shown in FIG. 1, the architecture 100 comprises a system on a chip (SoC) 102 and a companion module 120. The SoC 102 may be alternatively referred to herein as an SoC module, and be implemented as any suitable type of SoC based upon the hardware platform of which the SoC 102 forms a part and/or the particular application. In a non-limiting and illustrative scenario, the SoC 102 and the companion module 120 may be implemented as part of a hardware platform associated with a laptop computer, a mobile phone, a desktop computer, a wearable computing device, a base station for wireless communications, etc.

Regardless of the hardware platform in which the SoC 102 and the companion module 120 are implemented, the SoC 102 and the companion module 120 may communicate with one another via the data interface 103. Thus, the data interface 103 may represent any suitable number and/or type of ports, buses, wires, and/or wireless links to support bi-directional communications between the SoC 102 and the companion module 120. The data interface 103 may therefore comprise any suitable subset or combination of components implemented via the SoC 102 (such as local ports, buffers, drivers, communication circuitry, etc.), the companion module 120 (such as local ports, buffers, drivers, communication circuitry, etc.), and/or the interconnections between the SoC 102 and the companion module 120 (such as buses, wires, filters, communication circuitry, etc.).

The data interface 103 may support bi-directional communications in accordance with any suitable communication protocol and/or standard, and may support data transfer between the SoC 102 and the companion module 120 in accordance with any suitable frequency/speed. Thus, the data interface 103 may support data communications between the SoC 102 and the companion module 120 in accordance with any suitable data transmission and reception rates and/or frequencies. In accordance with a non-limiting and illustrative scenario, the data interface 103 may support speeds of 50 Mbit/second, 80 Mbit/second, 100 Mbit/second or greater, etc.

The data interface 103 may be configured to support any suitable type of data flow between the SoC 102 and the companion module 120 in accordance with the implementation of suitable hardware components (such as serial or parallel data flows). That is, the data interface 103 may support both standard communication protocols and non-standard (i.e. proprietary or custom) communication protocols in various applications, and may support any suitable type of hardware and data flow to ensure bidirectional communications as discussed herein between the SoC 102 and the companion module 120. As will be further discussed below, the data interface 103 may enable the transmission and reception of unencrypted data as well as encrypted data depending upon the particular mode of operation of the architecture 100.

To facilitate the various techniques as discussed herein, the SoC 102 may comprise any suitable type of architecture, components, and/or structure. The SoC 102 and the companion module 120 as shown in FIG. 1 and further discussed herein are provided in a non-limiting and illustrative manner, and it is understood that the SoC 102 and the companion module 120 may implement additional, fewer, or alternate components based upon the particular implementation, hardware platform, application, etc. Moreover, although the techniques are discussed herein with respect to the use of two modules in communication with one another (i.e. the SoC 102 and the companion module 120), this is also a non-limiting and illustrative scenario, and the techniques discussed herein may be expanded to include additional SoCs 102 and/or additional companion modules 120.

In any event, the SoC 102 comprises a central processing unit (CPU)/processing unit 104, a controller chipset 106 (also referred to herein as a controller or controller blocks, which may include any suitable number and/or type of functional blocks and/or processing circuitry as further discussed below), a program memory 110, and a secure memory 112. The CPU/processing unit 104 may be configured as any suitable number and/or type of processing circuitry and/or computer processors, which may function to control the SoC 102 and/or other components of the hardware platform in which the SoC 102 is implemented. The CPU/processing unit 104 may be identified with one or more processors (or suitable portions thereof) implemented by the SoC 102 or a host system. The CPU/processing unit 104 may be identified with one or more processors such as a host processor, a digital signal processor, one or more microprocessors, graphics processors, baseband processors, microcontrollers, an application-specific integrated circuit (ASIC), part (or the entirety of) a field-programmable gate array (FPGA), etc.

In any event, the CPU/processing unit 104 may be configured to carry out instructions to perform arithmetical, logical, and/or input/output (I/O) operations, and/or to control the operation of one or more components of the SoC 102 to perform the various functions as described herein. The CPU/processing unit 104 may include one or more microprocessor cores, memory registers, buffers, clocks, etc., and may generate electronic control signals associated with the components of the SoC 102 to control and/or modify the operation of these components. The CPU/processing unit 104 may communicate with and/or control functions associated with controller chipset 106, the program memory 110, and/or the secure memory 112.

The controller chipset 106 may include any suitable number and type of components to facilitate the control of predetermined data paths and to support functions used in conjunction with the CPU/processing unit 104. The controller chipset 106 may form part of a controller hub architecture, and be implemented as any suitable number of and/or type of silicon-based components, processing circuitry, etc. to execute this functionality. To provide some illustrative and non-limiting scenarios with respect to the controller chipset 106, some functions may comprise a real time clock and performing system clocking operations. Additionally or alternatively, the controller chipset 106 may perform wireless communication functions (such as Wi-fi) when the controller chipset 106 is used to support the CPU 102. Additional functions may include the controller chipset 106 performing Direct Media Interface (DMT) operations.

Thus, the controller chipset 106 may facilitate I/O functions being reassigned between the controller chipset 106 the CPU/processing unit 104. The controller chipset 106 may thus provide for offloading of a subset of functions for the CPU/processing unit 104 or execute driver-based functions to allow the controller chipset 106 to interface with operating system (OS) applications, which may additionally or alternatively include the controller chipset 106 functioning as a memory controller and providing data management such as via the use of peripheral component express (PCIe) data lanes. The peripheral management functionality of the controller chipset 106 is a primary focus of the disclosure, as this functionality encompasses the data communications between the SoC 102 and the companion module 120, which includes the establishment of trusted relationships and data encryption using security keys, as further discussed below.

To facilitate the peripheral data communication management functions as further discussed herein, the controller chipset 106 comprises connection control circuitry 108. Although shown as part of the controller chipset 106 in FIG. 1, it is noted this is a non-limiting and illustrative implementation, and the connection control circuitry 108 may form any suitable portion of the SoC 102, and thus likewise include any suitable combination of hardware components, processing circuitry, etc. However, it may be particularly advantageous to incorporate the connection control circuitry 108 as part of the controller chipset 106 to extend the peripheral management functionality of the controller chipset 106 in this manner. The connection control circuitry 108 may be implemented as a portion or subset of the controller chipset 106 that is dedicated to managing trust relationships with the companion module 120, as well as performing the various techniques as discussed in further detail herein with respect to the SoC 102 generating and/or exchanging keys, communicating with the companion module 120, encrypting and decrypting data communications between the SoC 102 and the companion module 120, etc.

Again, the connection control circuitry 108 may function to offload key processing and/or hardware elements (such as functional blocks) of one or more radio access technologies (RATs) of the companion module 120 to the SoC 102. Thus, the companion module 120 may comprise any suitable type of expansion card that supports any suitable type of wired and/or wireless communications in accordance with any suitable number and/or type of communication protocols, standards, RATs, etc. To provide an illustrative and non-limiting scenario, the companion module 120 may be implemented as a wireless expansion card that supports Wi-Fi communications, Bluetooth communications, wired Ethernet communications, etc. Continuing this scenario, the connection control circuitry may comprise functional blocks configured to perform wireless internet protocol (IP) functions, modulation, demodulation, etc. Thus, the companion module 120 may alternatively be referred to herein as companion card or companion circuitry, an expansion card, an expansion module, or as expansion circuitry.

As a result, the connection control circuitry 108 may be compatible with a set of different companion modules for which such functions are offloaded to the SoC 102 based upon the implementation of the SoC 102, the companion module 120, and the associated hardware platform in which the SoC 102 and the companion module 120 are implemented. Therefore, and as further discussed below, the SoC 102 and the companion module 120 may form part of a hardware platform that is associated with a predetermined hardware identifier, which may be a serial number or any other suitable type of identifier. This hardware platform identifier may enable the SoC 102 to determine the compatibility of images (i.e. firmware) executed by the connection control circuitry 108, as further discussed herein. Additional details regarding the components of the companion module 120 are further discussed below.

The memory 110 is configured to store data and/or instructions such that, when the instructions are executed by the connection control circuitry 108, the device SoC 102 performs the various functions as described herein. Again, these may include managing trust relationships with the companion module 120, performing the various techniques as discussed in further detail with respect to the SoC 102 generating and/or exchanging keys, communicating with the companion module 120, encrypting and decrypting data communications between the SoC 102 and the companion module 120, etc.

The memory 110 may be implemented as any well-known volatile and/or non-volatile memory (i.e. the memory 110 may comprise more than one type of memory or modules or different types), including read-only memory (ROM), random access memory (RAM), flash memory, a magnetic storage media, erasable programmable read only memory (EPROM), programmable read only memory (PROM), etc. The memory 110 may be non-removable, removable, or a combination of both. The memory 110 may be implemented as a non-transitory computer readable medium storing one or more executable instructions such as logic, algorithms, code, etc.

As further discussed below the program memory 110 may form part of the connection control circuitry 108 or be a separately implemented component. The program memory 110 may be configured as non-volatile memory, to which firmware, also referred to herein as an “image” may be written or “flashed” during manufacturing of the SoC 102 and/or during subsequent servicing phases. Thus, the instructions, logic, code, etc., stored in the program memory 110 may enable the functionality disclosed herein to be functionally realized.

The secure memory 112 may be implemented as any suitable type of non-volatile memory, including read-only memory (ROM), a one-time programmable (OTP) memory, flash memory, erasable programmable read only memory (EPROM), programmable read only memory (PROM), a set of programmable fuses, etc. The secure memory 112 may differ from the program memory 110 in that the secure memory 112 may represent a range of registers and/or addressable memory space that utilizes any suitable type of memory protective measures to prevent external access (i.e. access other than via the SoC 102), and which may be used to store security keys as further discussed herein. The memory protection measures may be of any suitable type, including known types. The secure memory 112 may be implemented as a protected addressable range of memory and/or registers of the program memory 110, or as a separate memory as shown in FIG. 1.

### III. Process Flows for Initial Power Up and During Ordinary Operation

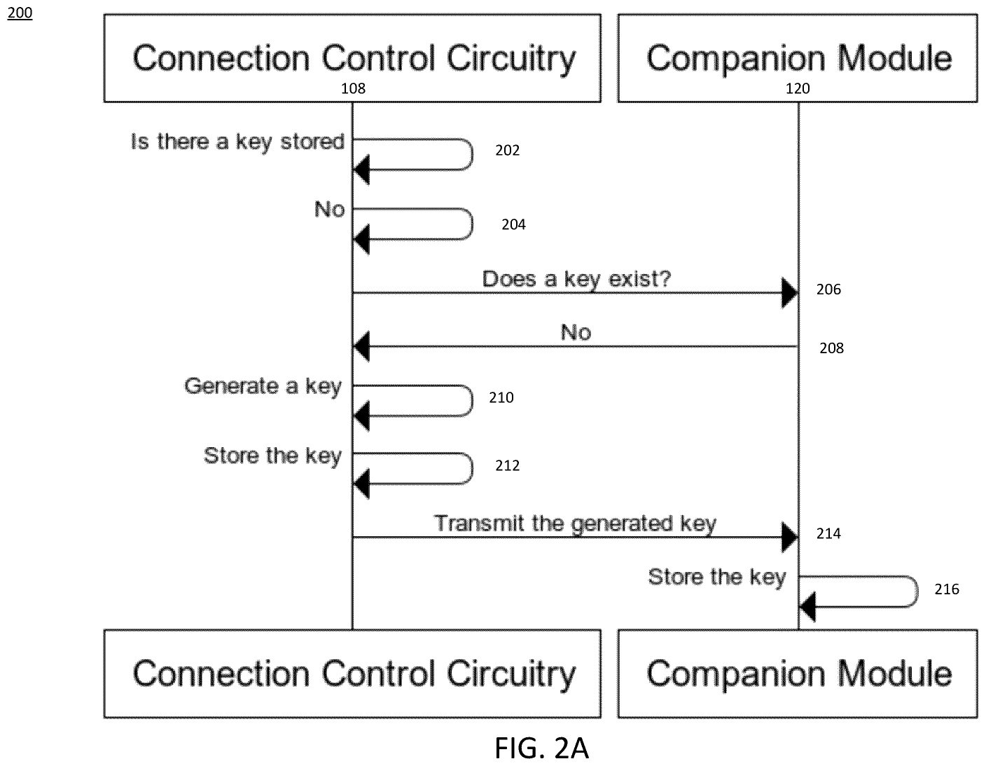

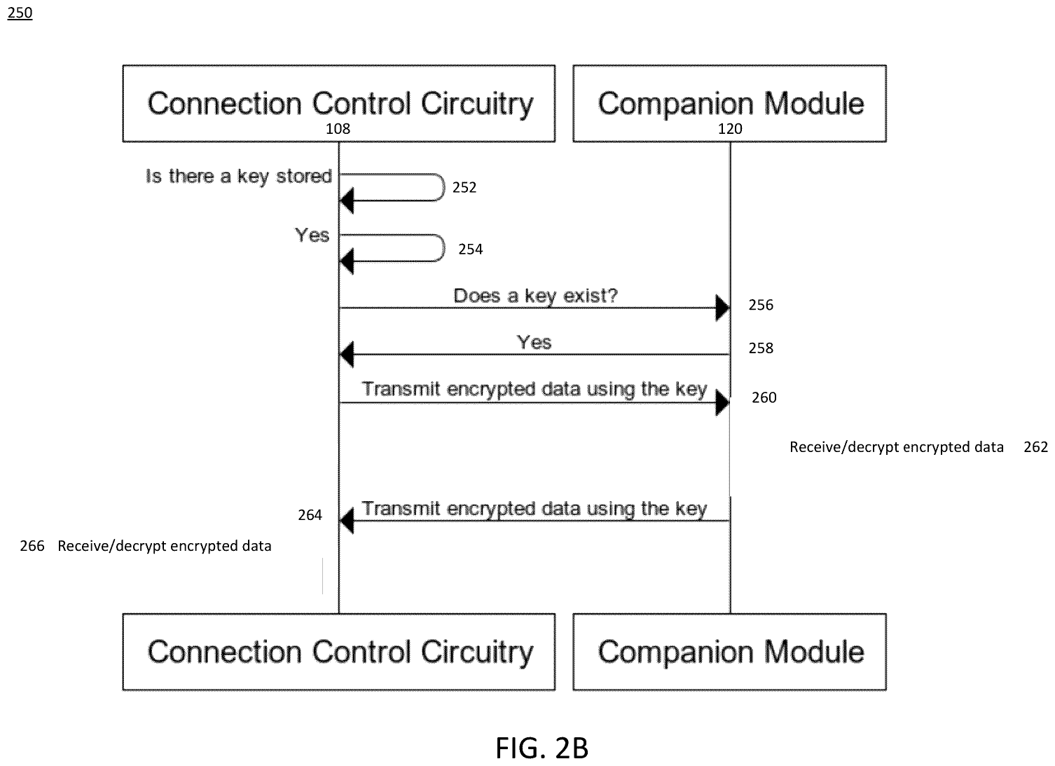

FIG. 2A illustrates a first power up Trust on First Use (TOFU) process flow, in accordance with the disclosure. To enable data interface encryption and avoid production key provisioning, a TOFU approach is implemented to handle all phases of device life cycles such as production, operational, maintenance, re-sku, debug, etc. The process flow as discussed with reference to FIG. 2A utilizes TOFU as part of an initial power up during which the SoC 102 and the companion module 120 are communicatively coupled to one another. In other words, the connection control circuitry 108 as noted above is configured to implement a TOFU authentication scheme to establish, on an initial power up of the SoC 102 while connected to a companion module 120, a trust relationship with the companion module 120.

To do so, the term “TOFU” as further discussed herein assumes that on an initial first boot sequence of the SoC 102, a key is transmitted from the SoC 102 to the companion module 120 on a plain (i.e. open or unencrypted data channel of the data interface 103). Then, once the key is stored in secure, nonvolatile memory in both sides, i.e. by both the SoC 102 and the companion module 120, the key may be used upon subsequent power ups during operation to encrypt data communications over the data interface 103. Thus, during the initial power up operation, neither the SoC 102 nor the companion module 120 has generated or stored a key, and thus the SoC 102 and the companion module 120 may be referred to as being in a “virgin,” or alternatively an “open” state. In this way, the techniques described herein do not require a change in the production flow, unlike the use of key provisioning, and the trust between the SoC 102 and the companion module 120 is established and maintained after production. Thus, the production of each side of the data interface 103 (i.e. the SoC 102 and the companion module 120) does not depend on a pre-established trust relationship with the other side, as the initial trust relationship formed by way of the process flow 200 may be completed without the creation of a “secure interface.”

The process flow as shown in FIG. 2A is performed in a controlled environment such as during production of the hardware platform that mates or pairs the SoC 102 and the companion module 120 as part of an initial process. Due to the process flow 200 being executed in such a controlled environment, unencrypted communications may be used as it is safely assumed that an adversary does not have physical access to the hardware platform at this point of time. Thus, the key sharing as shown in the process flow 200 of FIG. 2A is only performed upon an initial power up in a controlled environment, after which time the SoC 102 and the companion module 120 are “paired” based upon their respectively-stored keys (which are identical). Then, once the key is saved by the companion module 120, the same key is used for data encryptions via the data interface 103 and not transmitted again. If the system is subsequently “re-virginized” (i.e. restored to the open state) as further explained below, a new key will be generated and shared between the SoC 102 and the companion module 120.

With continued reference to FIG. 2A, the process flow 200 is again assumed to be executed during the initial power up of the SoC 102 while connected to the companion module 120 in a controlled or otherwise secure environment. This process flow begins when the connection control circuitry 108 determines (202) whether a key is stored on the SoC 102. This may be performed via the connection control circuitry 108 accessing the secure memory 112, which may include accessing a predetermined range of data registers and/or predetermined range of addresses known a priori to contain a security key. During the process flow 200, since no key has been previously generated or stored, the result of this operation will be “no” (204), i.e. the contents of the accessed portion of the secure memory 112 will be empty.

The connection control circuitry 108 then transmits (206) a query to the companion module 120 to check whether a key has been previously stored in the secure memory 126 of the companion module 120. It is noted that the secure memory 126 of the companion module 120 as shown in FIG. 1 may be implemented in a similar or identical manner as the secure memory 112 of the SoC 102. That is, the secure memory 126 may likewise be implemented as any suitable type of non-volatile memory, including read-only memory (ROM), a one-time programmable (OTP) memory, flash memory, erasable programmable read only memory (EPROM), programmable read only memory (PROM), a set of programmable fuses, etc. The secure memory 126 may represent a range of registers and/or addressable memory space that utilizes any suitable type of memory protective measures to prevent external access (i.e. access other than via the companion module 120), and which may be used to store security keys as further discussed herein. The memory protection measures may be of any suitable type, including known types.

That is, upon power up of the companion module 120, an internal finite state machine (FSM) identified with the companion module 120 (not shown) functions to read from various non-volatile memory location data items, among which there may be the key (if it exists). When a key does exist, the FSM of the companion module 120 will “signal” that the key exists, or else signal that “there is no key.” Thus, the signal transmission of 208 as shown in FIG. 2A represents an indication of the signal state identified by the FSM of the companion module 120, which is indicative of the presence or absence of the key stored in the secure memory 126. Similarly, for the SoC 102, a driver identified with the connection control circuitry 108 generates and provides to the connection control circuitry 108 a signal that the SoC key exists or that the SoC key does not exist. Thus, 204 as shown in FIG. 2A represents an indication of the signal state identified by the driver of the SoC 102 indicative of the presence (not shown) or absence (as shown in FIG. 2A) of the key stored in the secure memory 112.

Thus, in response to receiving the query (206), the companion module 120 may respond according to the current signal state identified by the FSM (208). During the process flow 200, since no key has been previously generated or stored, the result of this operation will be “no.” The companion module 120 thus transmits (208) data back to the connection control circuitry 108 indicating that no key is stored in the companion module 120. This communication may be transmitted on an open (i.e. unencrypted) channel, as a key has not yet been stored to facilitate encrypted communications.

Thus, at this stage in the process flow 200 the connection control circuitry 108 has determined that a key does not exist in the SoC 102 or in the companion module 120, and thus the “virgin” state of each module is confirmed as part of the initial power up process. Once this is confirmed, the connection control circuitry 108 generates (210) a key and stores (212) the key in the secure memory 112. Again, this may include writing the key to a predetermined range of data registers and/or predetermined range of addresses as noted above, such that subsequent checks regarding the presence of the key will result in accessing the key from this location.

The connection control circuitry 108 is configured to generate the key in accordance with any suitable number and/or type of key-generation techniques, including known techniques. In one non-limiting and illustrative scenario, the connection control circuitry 108 may implement a random number generator configured to generate a random number represented as a bit string of any suitable predetermined length, such as 128-bits, 256-bits, 512-bits, etc. In this context, the term “random” is understood as meaning random in the sense of generated by way of an algorithm or execution of dedicated hardware circuitry implemented via the connection control circuitry 108. Thus, the key may comprise a bit string having a random sequence of bits that may constitute a random number, a pseudorandom number, or otherwise be generated by way of any suitable type of random number generation.

In any event, once the connection control circuitry 108 generates and stores the key in the secure memory 112, the connection control circuitry 108 transmits (214) the generated key to the companion module 120 via the data interface 103. Again, the data transmission of the key (as well as other data communications) during this initial power up occur via an open, or unencrypted, data transmission via the data interface 103, as the key is used for encrypted communications and has not yet been stored by either the SoC 102 or the companion module 120. Upon receiving the key, the companion module stores (216) the key in the secure memory 126. This may include writing the key to a predetermined range of data registers and/or predetermined range of addresses as noted above, such that subsequent checks regarding the presence of the key will result in accessing the key from this location.

Once the key is stored in the secure memory 112, 126 of the SoC 102 and the companion module 120, respectively, the key may then be used to provide symmetric encryption of data for all subsequent communications between the SoC 102 and the companion module 120. Thus, the key length should be of a large enough length (128 bits, 256 bits, 512 bits, etc.) such that there is no need to replace the key over the product/platform lifetime. However, in the event that there is a need to replace the key in the future, the connection control circuitry 108 may generate a new replacement key, and the processes of 210, 212, 214, 216 of the process 200 may be repeated. In this case, the current key may be used to support encrypted data communications between the SoC 102 and the companion module 120 until the new key is stored in the SoC and the companion module 120, and thereafter the newly stored key may be used to support encrypted data communications. The encrypted data communications as discussed herein may be in accordance with any suitable type of symmetric data encryption between two participants in which a shared key is utilized, i.e. in which the key is used for encryption and decryption of data sent via the data interface 103. A non-limiting and illustrative scenario includes the use of the Advanced Encryption Standard (AES) to facilitate secured, encrypted communications between the SoC 102 and the companion module 120 via the data interface 103.

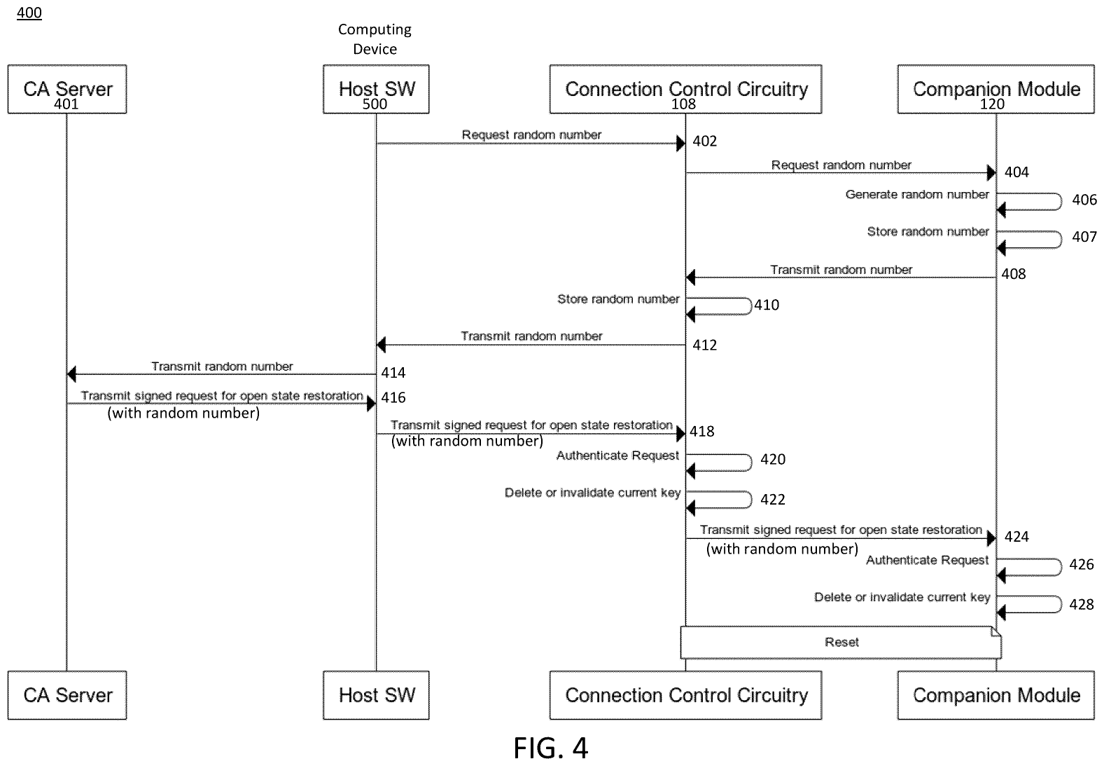

It is noted that to provide enhanced security measures, the security key may be exhausted or otherwise expire after a predetermined time period has elapsed and/or other suitable conditions (such as number of power-ups). Thus, the expiration of the security key may be based upon any suitable number of conditions, and may be dependent upon the particular application, key size, throughput, usage, etc. In any event, the current security key may need to be later replaced with a new, updated security key. To do so, the SoC 102 may generate and store a new security key (such as via the controller chipset 106), which is then transferred to the companion module 120 as part of an encrypted communication (i.e. encrypted using the current key). Once both the SoC 102 and the companion module 120 have stored the new key in their respective secure memory locations, the new updated security key will be used for future encrypted communications, and the old key (i.e. the current key prior to being updated) will then be invalidated. Additional details regarding the security key invalidation process are further discussed below with respect to the process flow 400 of FIG. 4.

FIG. 2B illustrates a power up operational process flow, in accordance with the disclosure. The process flow 250 as shown in FIG. 2B is identified with the operational mode of the architecture 100 after the initial power up as discussed above with respect to the process flow 200 of FIG. 2A has been completed. Thus, the process flow 250 may correspond to that of a user powering up the hardware platform that includes the architecture 100 after leaving the production environment.

As shown in FIG. 2B, the processes 252, 254, and 256 are identical to the processes 202, 204, 206 of the process flow 200 as shown in FIG. 2A. However, because the key has been stored in the SoC 102 and the companion module 120 after the completion of the process flow 200, the process includes the companion module 120 transmitting (258) an indication that a key does exist in the secure memory 126. In response, the connection control circuitry 108 may then transmit (260) encrypted data using the key that is stored in the secure memory 112, which the companion module 120 may then decrypt (262) using the key stored in the secure memory 126. Furthermore, the companion module 120 may then transmit (264) encrypted data using the key that is stored in the secure memory 126, which the connection control circuitry 108 may then decrypt (266) using the key stored in the secure memory 112. It is noted that the companion module 120 checks whether a key exists as part of this process, but does not have knowledge regarding whether the key is the same one used by the connection control circuitry 108. Thus, communication between the connection control circuitry 108 and the companion module 120 occurs only when each stores an identical key, as symmetrical encryption is used, and otherwise communication cannot occur other than via the initial processes 252, 254, 256, as the data exchanged during these processes is done over the open channel.

In this way, the connection control circuitry 108 and the companion module 120 are configured to utilize their respectively stored keys to perform encrypted communications with one another via the data interface 103 upon subsequent power ups of the SoC 102 (i.e. power ups subsequent to the initial “virgin” power up of the process flow 200) while connected to the companion module 120. In other words, and as can be seen in the “normal operation” case of the process flow 250, all other power ups use the key stored in the secure memories 112, 126 of the SoC 102 and the companion module 120, respectively. Thus, after a session that detects that both sides have a key (processes 252, 254, 256, 258), both sides start to use the key for encrypted communications. If the key is matched, there is no issue as the communications will be encrypted and will be decrypted normally. However, if the key is not matched, then the encrypted communications will fail.

### IV. Process Flows for Power Up during a Debugging Mode of Operation

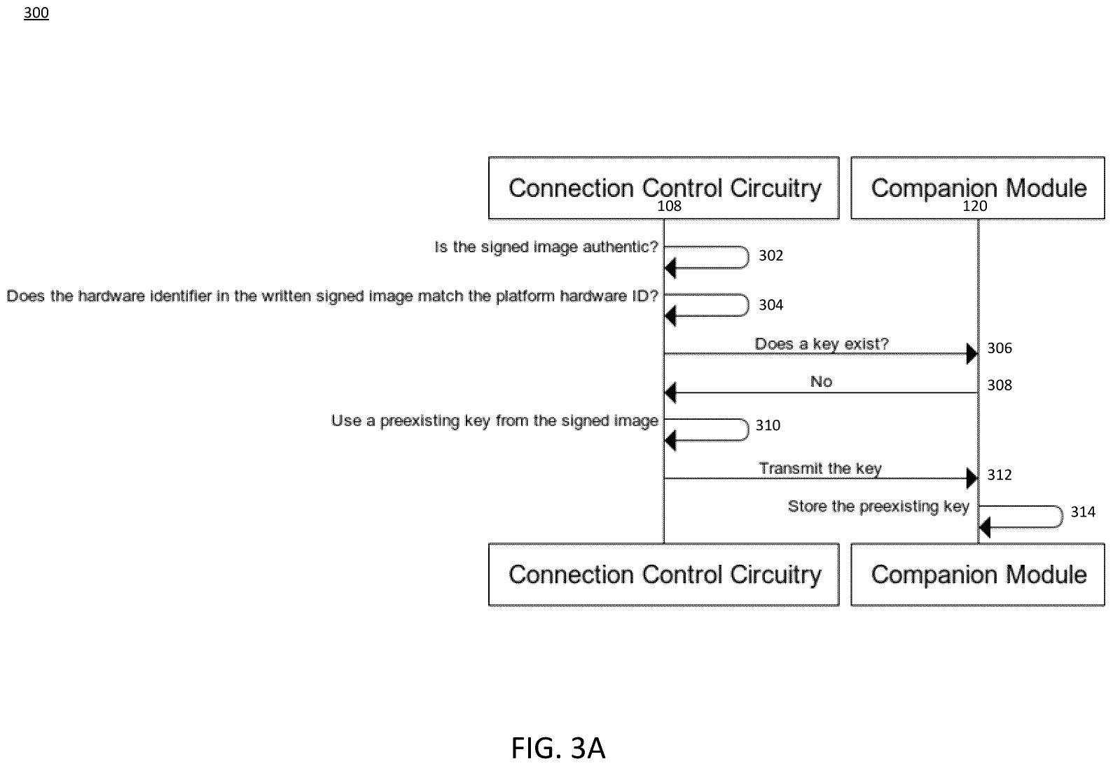

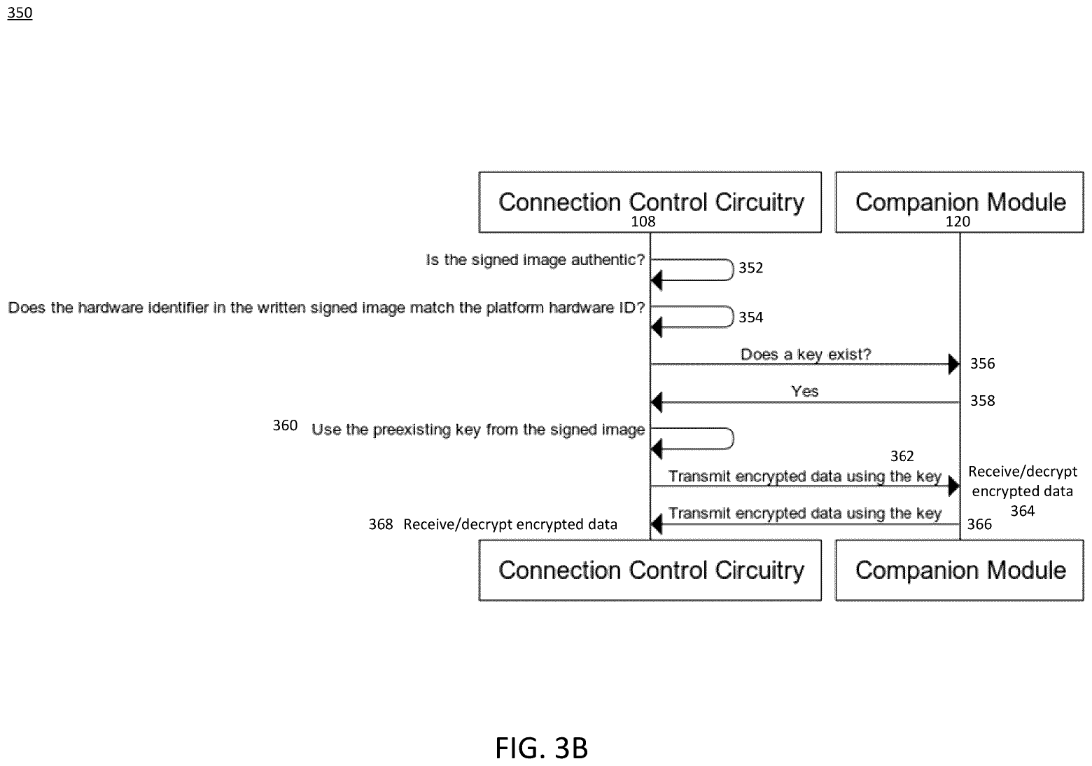

FIG. 3A illustrates a debug power up process flow in which a key is initially provided, in accordance with the disclosure. The process flows 300, 350 as shown in FIGS. 3A and 3B are typically performed in a controlled environment that implements the SoC 102 and the companion module 120. The process flows 300, 350 are associated with debugging modes of operation, i.e. in the case that either the product is under development or a user reports a malfunctioning companion module 120, and debugging needs to be performed to determine the root cause and/or to generate a report of the operational issues.

It is noted that it is critical that there cannot be any backdoor to the architecture 100 that may allow for malicious attacks. Therefore, prior to the process flows 300, 350 being performed, the SoC 102 and the paired companion module 120 are subjected to a “re-virginization” process in which the keys stored in the secure memory 112, 126 of the SoC 102 and companion module 120, respectively, are deleted or invalidated. The re-virginization process flow is alternatively referred to herein as an open state restoration process. The completion of the open state restoration process functions to restore the SoC 102 and the companion module 120 to their original open (i.e. unpaired) state prior to the initial power up as discussed above with reference to the process flow 200. Thus, for both the process flows 200, 300, it is assumed that the SoC 102 and the companion module 120 are in the open state such that neither the SoC 102 nor the companion module 120 stores a valid key. The open state restoration process is further discussed below with reference to FIG. 4.

Again, the process flows 300, 350 as further discussed herein with respect to FIGS. 3A and 3B are identified with debugging modes of operation, which may take place in a controlled or otherwise secure environment such as a development lab. The process flows 300, 350 as shown in FIGS. 3A and 3B may be performed with respect to any two pairs of the SoC module 102 and the companion module 120, and requires that the image (i.e. firmware) used is signed for debugging use. This signed image is also “tied” to specific hardware platform identifier, which may be associated with the hardware platform of which the SoC 102 and the companion module 120 form a part, and which is identified with a predetermined hardware identifier as noted above. The SoC 102 has access to the predetermined hardware identifier, which may be a serial number, a stock keeping unit (SKU) number, or any other suitable type of unique identifier associated with the hardware platform.

To perform the debugging mode of operation, a signed image identified with executable firmware is first written (such as being “flashed”) to any suitable memory portion of the SoC 102, which is executed via the connection control circuitry 108 to perform the process flows 300, 350, as the case may be. The portion of the SoC 120 to which the signed image is written may be the program memory 110, the secure memory 112, or any other suitable memory accessible by the connection control circuitry 108 (such as memory integrated as part of the connection control circuitry 108). It is further noted that each firmware that is executed on the SoC 102 is first authenticated, as un-authenticated firmware will be rejected and thus not executed. Therefore, and as further discussed below, the primary difference between the flows 300, 350 as shown in FIGS. 3A and 3B, respectively, and the flows 200, 250 as shown in FIGS. 2A and 2B, respectively, is that for the flows 300, 350 the firmware is authenticated and also attached (i.e. linked) to a specific hardware platform identifier. Thus, for the flows 300, 350 the firmware needs to meet both the authentication and hardware platform identifier conditions, whereas for the flows 200, 250 the operational firmware need only be authenticated without verifying or otherwise checking compatibility with the hardware platform identifier.

Thus, and turning now to the process flow 300 as shown in FIG. 3A, the process flow 300 is identified with an initial power up of the SoC 102 while connected to the companion module 120 in the debugging mode of operation. The process flow 300 is implemented via the connection control circuitry 108 executing the signed image (which is identified with executable firmware) to operate in the debugging mode of operation. To do so, the connection control circuitry 108 first authenticates (302) the signed image. This may include the connection control circuitry 108 authenticating the signed image that is going to be executed by the connection control circuitry 108, which is not the case for the normal mode of operation as shown and discussed above with respect to the process flow 250. This may include the connection control circuitry 108 reading the signed image and identifying a specific version number, a predetermined coded identifier, etc., as part of a secure boot loading procedure. In other words, the connection control circuitry 108 authenticates the signed image by verifying that the firmware about to be executed to enter the debugging mode of operation has been signed by a trusted entity.

Once the signed image is authenticated, the process flow 300 includes the connection control circuitry 108 determining (304) whether the hardware identifier contained in the signed image matches the predetermined hardware identifier accessed by the SoC 102. Thus, in a non-limiting and illustrative scenario, the signed image written to the SoC 102 may be customized to the hardware platform on which the SoC 102 is implemented. In this way, the connection control circuitry 108 may verify the compatibility of the signed image by matching a hardware platform identifier that is accessed by the SoC 102 to the hardware identifier contained in the signed image, and only continue operation in the debugging mode of operation when the hardware platform identifier is verified in this manner. Otherwise, the connection control circuitry 108 may not enter into the debugging mode of operation.

Once the signed image is checked for compatibility to run in the debugging mode on that specific hardware platform, the process flow 300 may include the connection control circuitry 108 transmitting (306) a query to the companion module 120 to check whether a key has been previously stored in the secure memory 126 of the companion module 120. Since no key has been previously generated or stored (i.e. the SoC 102 and the companion module 120 are assumed to have been restored to the open state), the result of this operation will be “no,” i.e. the contents of the accessed portion of the secure memory 126 will be empty. The companion module 120 thus transmits (308) data back to the connection control circuitry 108 indicating that no key is stored in the companion module 120.

In such case, the process flow uses (310) a preexisting key that is included as part of the signed image (i.e. written to the firmware). It is noted that in contrast with the generation of the key via a random number generator as was the case for the process flow 200, the use of the signed image allows for the use of a preexisting key that has been already generated and included as part of the signed image firmware data. Once the connection control circuitry 108 accesses the key from the signed image in this manner, the connection control circuitry 108 transmits (312) the obtained key to the companion module 120 via the data interface 103. Again, this data transmission of the key during this initial debug power up is via an open, or unencrypted, data transmission via the data interface 103. Upon receiving the key, the companion module 120 stores (314) the key in the secure memory 126. This may include writing the key to a predetermined range of data registers and/or predetermined range of addresses as noted above, such that subsequent checks regarding the presence of the key will result in accessing the key from this location, as further discussed below with respect to the process flow 350 as shown in FIG. 3B.

FIG. 3B illustrates a subsequent debug power up process flow using the previously-provided key, in accordance with the disclosure. The process flow 350 as shown in FIG. 3B is identified with the debug mode of the architecture 100 after the initial debug power up as discussed above with respect to the process flow 300 of FIG. 3A has been completed. In other words, and as was the case for the process flow 300, the process flow 350 may occur on a subsequent power up of the SoC 102 while connected to the companion module 120 by executing the signed image to operate in the debugging mode of operation.

As shown in FIG. 3B, the processes 352, 354, 356 are identical to the processes 302, 304, 306 of the process flow 300 as shown in FIG. 3A. However, because the key has been stored by the companion module 120 after the completion of the process flow 300, the process 358 includes the companion module 120 transmitting (308) an indication that a key does exist in the secure memory 126. In response, the connection control circuitry 108 may then use (360) the preexisting key obtained via the signed image, and transmit (362) encrypted data using the key. The companion module 120 may then decrypt (364) the received encrypted data using the key stored in the secure memory 126. Furthermore, the companion module 120 may then transmit (366) encrypted data using the key that is stored in the secure memory 126, which the connection control circuitry 108 may then decrypt (368) using the key accessed via the signed image. As noted above for the process flows 200, 250, the encrypted communications during the debugging mode of operation represented by the process flows 300, 350 may also comprise symmetric encrypted communications, but in the case of the debugging mode of operation a preexisting security key is used for encryption and decryption of data sent via the data interface 103 versus a generated key.

### V. A Process Flow for Performing an Open State Restoration

FIG. 4 illustrates an open state restoration process flow to restore the modules to an open state, in accordance with the disclosure. The process flow 400 as shown in FIG. 4 is performed to restore the SoC 102 and the companion module 120 to an open state, i.e. the initial state in which the SoC 102 and the companion module 120 do not store valid keys in their respective secure memories 112, 126. Thus, upon completion of the process flow 400, the SoC 102 and the companion module 120 are in the same state as shown in the beginning of the process flows 200, 300 as noted above.

The process flow 400 may be implemented for any suitable purpose, but may be particularly advantageous for customer returns or when the product is going to be re-sold, or when an issue with the hardware platform, the SoC 102, and/or the companion module 120 exists and needs to be identified and rectified. In one illustrative use case scenario, a customer may request an analysis of the root cause of the problem. Thus, the process flow 400 may be executed in a controlled environment upon receiving a customer return of a hardware platform that includes the SoC 102 and the companion module 120. As a result, the process flow 400 may be utilized after the hardware platform comprising the SoC 102 and the companion module 120 was shipped and operated. In such a case, the initial power up process flow 200 has already been performed and the key generated and stored in respective secure memories 112, 126 of the SoC 102 and the companion module 120. The process flow 400 may thus be used to restore the SoC 102 and/or the companion module 120 to an open state, thereby enabling replacement of one (or both) sides of the data interface 103. Alternatively, the process flow 400 may be performed in an uncontrolled environment, such as via an end user.

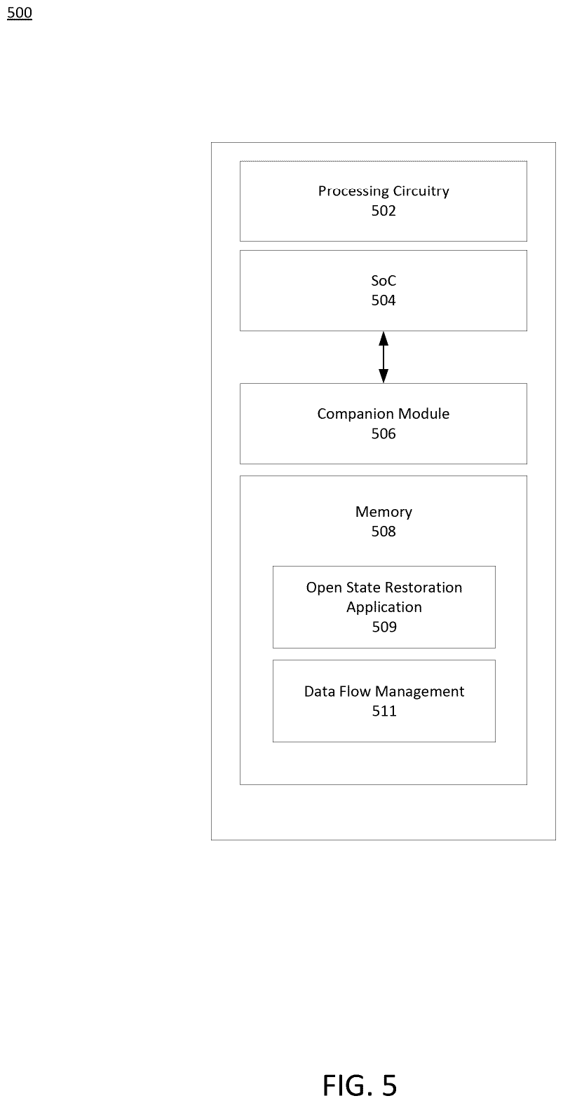

In any event, to facilitate the process flow 400, a host software application may be installed on any suitable computing device that communicates with a certificate authority (CA) server 401 and the connection control circuitry 108. The computing device that executes the host software application may be any suitable type of computing device, which may include the same computing device that is identified with the hardware platform comprising the SoC 102 and the companion module 120. Thus, the computing device that runs the host software application in this manner may be identified with the electronic device 500 as discussed in further detail herein with respect to FIG. 5. Alternatively, the computing device executing the host software application may be identified with a separate device that is communicatively coupled to the connection control circuitry 108 and the companion module 120. Thus, the host software may be installed in a controlled environment in the case of processing a returned product or, alternatively, installed via an end user by downloading and installing the host software from the CA server 401 via a network connection such as the Internet.

The computing device on which the host software application is executed is configured to communicate with the CA server 401 and the connection control circuitry 108 in any suitable manner to facilitate the processes of the process flow 400 as shown in FIG. 4 and further discussed herein. Such communication may be performed in accordance with any suitable number and/or type of communication protocols, including known types. In a non-limiting and illustrative scenario, the computing device on which the host software application is executed may communicate with the CA server 401 and the connection control circuitry 108 in accordance with one or more application programming interfaces (APIs), network communications, wireless links, hardwired interfaces, dedicated data interfaces, etc. Thus, although the component identified with the process flow 400 as shown in FIG. 4 may be referenced herein as the “host software,” it is understood that the processes performed by the host software are carried out by the computing device on which the host software is executed.

The certificate authority (CA) server 401 may be identified with any suitable type of remote computing system, with which the electronic device 500 identified with the host software may communicate. This communication may be facilitated via an application programming interface, and thus may implement a network connection such as a connection via the Internet. The CA server 401 may be implemented as any suitable type of system having any suitable architecture and/or network. Although referred to herein as a “server,” the CA server 401 may constitute one or several physical computers, servers, processors, etc. that comprise such a system. As another example, the CA server 401 may be implemented as an edge computing system and/or network.

In any event, the CA server 401 is authorized by a trusted entity to issue the open state restoration command as a signed request. Therefore, and as further discussed below, the host software, connection control circuitry 108, and the companion module 120 may each authenticate the signed request to confirm the issuance of the command from a trusted entity. Thus, the CA server 401 may be identified with a private key, and be configured to sign a transmitted request for the connection control circuitry 108 and the companion module 120 to perform an open state restoration process. The signed request may be authenticated based upon any suitable authentication scheme in conjunction with the use of the random number verification, as shown in FIG. 4. The authentication process may include the use of public and private key pairs, with the host software, the connection control circuitry 108, and the companion module 120 having access to the public keys as part of an authentication process, as further discussed below.

Thus, and turning now to the process flow 400 as shown in FIG. 4, the process flow 400 is identified with the restoration of the SoC 102 and the companion module 120 to the open state in which no valid key is stored on the SoC 102 or the companion module 120, as noted above. The process flow 400 begins with the power up of the SoC 120 while connected to the companion module 120 in the debugging mode of operation. The process flow 400 is initially implemented via the host software (i.e. the computing device identified with the execution of the host software) transmitting (402) a request for the companion module 120 to generate a random number. This is facilitated by way of indirect communications with the companion module 120 via the connection control circuitry 108, as shown in FIG. 4. Thus, the host software transmits (402) the request to the connection control circuitry 108, which in turn receives, processes, and re-transmits (i.e. forwards, (404)) this request to the companion module 120. In response to this request, the companion module 120 generates (406) a random number and transmits (408) the random number back to the connection control circuitry 108.

To generate the random number, the companion module 120 may implement random number generator circuitry 122, as shown in FIG. 1. This random number generator circuitry 122 may be implemented in accordance with any number and/or type of software techniques, hardware techniques, or combinations of these. The random number generator circuitry 122 may facilitate any suitable architecture, including known types, to generate the random number. The random number generated via the random number generator circuitry 122 may be generated in a similar or identical manner as the key generated by the connection control circuitry 108 as discussed above with reference to the process flow 200. Alternatively, the random number generated by the companion module 120 may be generated in a different manner, have a different bit length, be generated using a different algorithm, etc., compared to the key generation implemented by the connection control circuitry 108. In any event, the random number generated by the companion module 120 may likewise be represented as a bit string of any suitable predetermined length, such as 128-bits, 256-bits, 512-bits, etc. Again, in this context, the term “random” is understood as meaning random in the sense of generated by way of an algorithm or execution of dedicated hardware circuitry implemented via the companion module 120. Thus, the key may comprise a bit string having a random sequence of bits that may constitute a random number, a pseudorandom number, or otherwise be generated by way of any suitable type of random number generation.

Although the process flow 400 also generates a random number similar to the random number used for the security key of the process flow 200, the random number generated in the process flow 400 differs in how it is used. That is, the key generated for the process flow 200 is intended to permanently pair (i.e. excepting for the use of the open state restoration process) the SoC 102 and the companion module 120 with one another, and is used for encrypted communications during ordinary lifetime operation, as discussed above. In contrast, the random number generated in the process flow 400 is intended to only be used a limited number of times, i.e. as a temporary measure to authenticate the different processes of the process flow 400, and is then deleted or otherwise invalidated.

To implement the temporary usage of the random number, the companion module 120 is configured to store (407) the random number in a predetermined addressable location. However, the memory used to store the random number in the process flow 400 is a volatile memory instead of the non-volatile memory used to store the generated key of the process flow 200. Thus, the predetermined location of memory in the companion module 120 may comprise a register or other suitable predetermined addressable space identified with any suitable type of volatile memory, such as random access memory (RAM). This volatile memory location may be part of a memory that is integrated as part of the companion module 120, which is not shown in the Figures for purposes of brevity.

Upon receiving the random number transmitted (408) from the companion module 120, the connection control circuitry 108 is configured to store (410) the random number in a predetermined addressable location of the SoC. Again, as was the case for the companion module 120, the memory used to store the random number by the connection control circuitry 108 is a volatile memory location. Thus, the predetermined location of memory may comprise a register or other suitable predetermined addressable space identified with any suitable type of volatile memory, such as random access memory (RAM). This volatile memory location may be part of a memory that is integrated as part of the connection control circuitry 108, the SoC 102, the program memory 110, or any other suitable volatile memory location, which may not be shown in the Figures for purposes of brevity.

Thus, the random number generated in this manner may comprise a number only used once (nonce). In accordance with such implementations, after the open state restoration process identified with the process flow 400 has been completed and the connection control circuitry 108 and the companion module 120 have been reset, the random number is deleted or otherwise no longer accessible to the connection control circuitry 108. Thus, the generation and verification of a nonce ensures that an adversary that is snooping communications between any of the components of the process flow 400 cannot repeat the open state restoration process by using the same nonce. In other words, the random number may only be used for a single open state restoration session.

Alternatively, the random number may comprise a number that is identified with a predetermined number of open state restoration processes greater than one. In accordance with such an implementation, the random number may be stored in a volatile memory location or a non-volatile memory location, but the CA server 401 may determine whether the random number has been previously used and, if so, how many times and/or when the random number was previously used. The CA server 401 may be configured to recognize a limited number of uses of the random number over a predetermined number of resets and/or invalidate the random number from a previous use after the expiration of a predetermined period of time. In this way, the use of the random number to authenticate open state restoration requests as discussed herein may be used any suitable number of limited times to allow for an acceptable tradeoff between security and convenience.

In any event, once the connection control circuitry 108 stores the random number, the connection control circuitry transmits (412) the random number back to the host software, thereby complying with the initial request (402). Once the host software receives the random number, the host software transmits (414) the random number to the CA server 401, and may additionally transmit any other suitable type of data indicating to the CA server 401 that an open state restoration process is being requested. The CA server 401 may then, in response to valid requests (414), transmit (416) to the host software a signed request for an open state restoration process to be requested. In other words, the CA server 401 only signs valid requests for open state restoration, which may be implemented using any suitable techniques, including known techniques, that enable the CA server 401 to identify valid requests from hosts to provide a signed response using a host-CA trust model. The request transmitted by the CA server 401 in this manner may be signed by way of the certificate stored in the CA server 401, which may implement a public-private key pairing with the host software, the connection control circuitry 108, and the companion module 120. The signed request additionally includes the random number that was originally generated (406) by the companion module 120 and transmitted (414) to the server 401.

Thus, the host software authenticates the signed request in any suitable manner using the public-private key pairing between the host software and the CA server 401. However, as an additional layer of security, the host software also verifies that the random number included in the signed request matches the random number that was previously-transmitted to the CA server 401. Assuming that this is the case, the process flow 400 continues, and the host software transmits (i.e. forwards, 418) the signed request received from the CA server 401 to the SoC 102 (i.e. to the connection control circuitry 108). Again, this forwarded signed request also includes the previously-generated random number.

The connection control circuitry 108 likewise authenticates (420) the request by verifying the private-public key pairing between the connection control circuitry 108 and the CA server 401, and also verifies that the random number stored in the volatile memory location matches the random number included in the signed request. To do so, the connection control circuitry 108 may implement any suitable type of authentication scheme in accordance with any suitable number and/or type of software techniques, hardware techniques, or combinations of these. The connection control circuitry 108 may facilitate any suitable architecture, including known types, to perform such authentication measures. Assuming that the signed request is authenticated and the random number matches the previously stored (410) random number, the connection control circuitry 108 then deletes or invalidates (422) the security key currently stored in the non-volatile memory location.

To provide a non-limiting and illustrative scenario with respect to the invalidation of the security key, the key may be stored with an allocated bit field comprising any suitable number of bits, such as 2, 4, 8, etc., which may represent a portion of the security key or a separate bit field. This bit field may be stored in the secure memory 112 of the SoC 102 with the security key, which again may represent a non-volatile memory location, and may be optionally stored in an OTP (which may be implemented via the secure memory 112). When stored in a OTP memory, the bits within the bit field may be written or “burned” into the secure memory 112 such that a bit field represented as a “1” cannot be changed back to a “0.” Thus, if 2 bits are allocated as noted in the illustrative scenario above, predetermined bit patterns of the bit field may be identified with valid and invalidated security keys.

That is, an initial bit field of 00 may be identified with an invalidated or nonexistent security key. Thus, once the security key is initially written to the secure memory 112, the bit field is then set to a predetermined bit pattern recognized with key validity, such as 01 or 10. Then, to subsequently invalidate the key, the 2 bit field is altered to 11, which may represent a predetermined bit pattern of an invalidated security key. This bit field, once set to 11, cannot be reverted back to 00, 01, or 10. Therefore, the secure memory 112 may reserve or otherwise allocate space for the storage of any suitable number (such as 1) of control bytes to support any suitable predetermined number of number of re-virginizations or security key invalidations.

To provide an illustrative and non-limiting scenario, a control byte may be initially represented as 0x00, and changed to 0x01 once the first security key is stored. To then invalidate the first security key, the control byte is changed to 0x03, and once a second security is stored, the control byte may be changed to 0x07, changed to 0x0F to invalidate the second security key, and so on. It is noted that bits stored in OTP cannot be deleted or erased, although the SoC 102 may utilize additional or alternate secure memory 112 to facilitate changes to the control byte. In this way, any suitable combination of secure memory, OTP memory, etc. may be implemented to support any suitable number and/or type of key validation/invalidation schemes.

Once this process has been completed, the connection control circuitry 108 transmits (i.e. forwards, 424) the signed request received from the CA server 401 to the companion module 120 to perform the open state restoration process. Again, this forwarded signed request also includes the previously-generated random number. The companion module 120 likewise authenticates (426) the request by verifying the private-public key pairing between the companion module 120 and the CA server 401, and also verifies that the previously-generated random number matches the random number that was previously stored (407).

To do so, the companion module 120 may implement authentication circuitry 124, as shown in FIG. 1. This authentication circuitry 124 may be implemented in accordance with any number and/or type of software techniques, hardware techniques, or combinations of these. The authentication circuitry 124 may facilitate any suitable architecture, including known types, to perform authentication measures, which may also be utilized by the connection control circuitry 108 as discussed above. In any event, once the signed request has been authenticated in this manner, the companion module 120 then deletes or invalidates (428) the key currently stored in the non-volatile memory location.

The connection control circuitry 108 and the companion module 120 may then be reset (such as via a reboot instruction, a manual power toggle, etc.). Once reset, both the connection control circuitry 108 and the companion module 120 are restored to an open or “virgin” state in which no valid key is stored on the SoC 102 or the companion module 120. Thus, in response to receiving and authenticating the signed request from the CA server 401 and verifying the presence of the correct random number, the host software causes the SoC 102 and the companion module 120 to delete their respectively stored keys (pending their own authentication and random number validation processes), thereby restoring the SoC 102 and the companion module 120 to an open state. Again, the random number is no longer valid upon reset (or only valid a limited number of times after a reset). Thus, the use of the random number in this manner in combination with an authentication of a signed request enables an enhanced security measure that prevents adversarial attempts to access the SoC 102 and/or the companion module 120 or to maliciously request an open state restoration process be performed.

### VI. An Electronic Device

FIG. 5 illustrates an electronic device, in accordance with the disclosure. The components shown in FIG. 5 are provided for ease of explanation, and the electronic device 500 may implement additional, less, or alternative components as those shown in FIG. 5. The electronic device 500 may be identified with any suitable type of device that implements a hardware platform that includes the architecture 100 as discussed herein. The electronic device 500 may be implemented as the entirety of or a portion of any suitable type of system and/or platform that implements the architecture 100. In the non-limiting and illustrative scenario as shown in FIG. 5, the electronic device 500 may comprise any suitable type of electronic device and/or computing device that is configured to perform wired and/or wireless communications in accordance with the functionality provided by the companion module 120 as discussed herein. The electronic device 500 may be implemented as a user equipment (UE) such as a mobile phone, a laptop computer, a tablet computer, a desktop computer, a wearable device, etc.

The electronic device 500 may include processing circuitry 502, an SoC 504, a companion module 506, and a memory 508. The processing circuitry 502 may be integrated as part of the SoC 504 (such as the CPU/processing unit 104, the controller chipset 106, etc.), although alternatively the processing circuitry 502 may form processing circuitry that operates independently of the SoC 504. The processing circuitry 502 may be configured as any suitable number and/or type of processing circuitry and/or computer processors, which may function to control the device 500 and/or other components of the electronic device 500. The processing circuitry 502 may be identified with one or more processors (or suitable portions thereof) implemented by the electronic device 500 or a host system. The processing circuitry 500 may be identified with one or more processors such as a host processor, a digital signal processor, one or more microprocessors, graphics processors, baseband processors, microcontrollers, an application-specific integrated circuit (ASIC), part (or the entirety of) a field-programmable gate array (FPGA), etc.

In any event, the processing circuitry 502 may be configured to carry out instructions to perform arithmetical, logical, and/or input/output (I/O) operations, and/or to control the operation of one or more components of electronic device 500 to perform various functions as described herein. The processing circuitry 502 may include one or more microprocessor cores, memory registers, buffers, clocks, etc., and may generate electronic control signals associated with the components of the electronic device 500 to control and/or modify the operation of these components. The processing circuitry 502 may communicate with and/or control functions associated with the SoC 504, the companion module 506, and/or the memory 508.

The SoC 504 and the companion module 506 may each be respectively identified with the SoC 102 and the companion module 120 as discussed herein. The electronic device 500 may be identified with the computing device that executes the host software application as discussed above with respect to FIG. 4 to perform the open state restoration process 400. Thus, the memory 508 stores data and/or instructions such that, when the instructions are executed by the processing circuitry 502, cause the electronic device 500 to perform various functions as described herein with respect to the execution of the host software as part of the open state restoration process. This may include handling communications between the electronic device 500 and the CA server 401, as well as handling communications between the between the electronic device 500 and the connection control circuitry 108.

The memory 508 may be implemented as any well-known volatile and/or non-volatile memory, including read-only memory (ROM), random access memory (RAM), flash memory, a magnetic storage media, an optical disc, erasable programmable read only memory (EPROM), programmable read only memory (PROM), etc. The memory 508 may be non-removable, removable, or a combination of both. The memory 508 may be implemented as a non-transitory computer readable medium storing one or more executable instructions such as, for example, logic, algorithms, code, etc.

As further discussed below, the instructions, logic, code, etc., stored in the memory 508 are represented by the various modules as shown, which may enable the functionality disclosed herein to be functionally realized. Alternatively, the modules as shown in FIG. 5 that are associated with the memory 508 may include instructions and/or code to facilitate control and/or monitor the operation of hardware components implemented via the electronic device 500. In other words, the modules shown in FIG. 5 are provided for ease of explanation regarding the functional association between hardware and software components. Thus, the processing circuitry 502 may execute the instructions stored in these respective modules in conjunction with one or more hardware components to perform the various functions as discussed herein.

The executable instructions stored in the open state restoration application module 509 may facilitate, in conjunction with execution via the processing circuitry 502, the electronic device 500 executing the processes identified with the open state restoration process flow as shown in FIG. 4.

The executable instructions stored in the data flow management 511 may facilitate, in conjunction with execution via the processing circuitry 502, the device 500 encoding and transmitting data to the CA server 401 and the connection control circuitry 108. The instructions stored in the data flow management module 511 also facilitates receiving and decoding the data received from the CA server 401 and the connection control circuitry 108. The executable instructions stored in the data flow management module 511 may facilitate, in conjunction with execution via the processing circuitry 502, the electronic device 500 facilitating such communications in accordance with one or more application programming interfaces (APIs) as noted above with respect to the process flow of FIG. 4.

### VII. General Operation of a “Virgin” SoC

A system on a chip (SoC) is provided. The SoC comprises a processing unit and connection control circuitry configured to implement a trust on first use (TOFU) authentication scheme to establish, on an initial power up of the SoC while connected to a companion circuitry, a trust relationship with the companion circuitry by: storing a key in a predetermined addressable location of the SoC when the connection control circuitry has determined that a key is not stored in the SoC or in the companion circuitry; and transmitting the key to the companion circuitry via a data interface, wherein, upon receiving the key, the companion circuitry stores the key in a predetermined addressable location of the companion circuitry. Furthermore, the connection control circuitry is configured to transmit the key to the companion circuitry using an unencrypted transmission. In addition or in alternative to and in any combination with the optional features previously explained in this paragraph, the connection control circuitry is further configured to, upon subsequent power ups of the SoC while connected to the companion circuitry, utilize the stored key to perform encrypted communications with the companion circuitry via the data interface. In addition or in alternative to and in any combination with the optional features previously explained in this paragraph, the encrypted communications comprise symmetric encryption communications in which the key is used for encryption and decryption of data sent via the data interface. In addition or in alternative to and in any combination with the optional features previously explained in this paragraph, the connection control circuitry is configured to generate the key via a random number generator. In addition or in alternative to and in any combination with the optional features previously explained in this paragraph, the connection control circuitry is configured to store the key in a non-volatile memory. In addition or in alternative to and in any combination with the optional features previously explained in this paragraph, the companion circuitry comprises an expansion card configured to support wireless communications.

### VIII. General Operation of an SoC During Debugging Operations

A system on a chip (SoC) is provided. The SoC comprises a processing unit and connection control circuitry configured to (i) communicate with a companion circuitry via a data interface, the SoC and companion circuitry forming part of a hardware platform associated with a predetermined hardware identifier, and (ii) upon an initial power up of the SoC while connected to the companion circuitry, execute a signed image identified with executable firmware to operate in a debugging mode of operation by: upon verifying that a hardware identifier of the signed image matches the predetermined hardware identifier, storing a preexisting key contained in the signed image; transmitting the preexisting key to the companion circuitry via the data interface; and on a subsequent power up of the SoC while connected to the companion circuitry, executing the signed image to operate in the debugging mode of operation by: verifying that the companion circuitry has stored the preexisting key; and using the preexisting key to perform encrypted communications with the companion circuitry via the data interface. Furthermore, the encrypted communications comprises symmetric encrypted communications in which the preexisting key is used for encryption and decryption of data sent via the data interface. In addition or in alternative to and in any combination with the optional features previously explained in this paragraph, the SoC is configured to, upon a subsequent power up of the SoC while connected to the companion circuitry, execute the signed image to operate in the debugging mode of operation only upon verifying that the hardware identifier of the signed image matches the predetermined platform hardware identifier. In addition or in alternative to and in any combination with the optional features previously explained in this paragraph, the connection control circuitry is configured to transmit the preexisting key to the companion circuitry using an unencrypted transmission. In addition or in alternative to and in any combination with the optional features previously explained in this paragraph, the companion circuitry is configured to store the preexisting key in a non-volatile memory. In addition or in alternative to and in any combination with the optional features previously explained in this paragraph, the companion circuitry comprises an expansion card configured to support wireless communications.

### IX. General Operation of an Electronic Device to Perform “Re-Virginization”

An electronic device is provided. The electronic device comprises a system on a chip (SoC) communicatively coupled to a companion circuitry, a memory configured to store computer-readable instructions, and processing circuitry configured to execute the computer-readable instructions to restore the SoC and the companion circuitry to an open state in which no key is stored on the SoC or the companion circuitry by: transmitting a request to the companion circuitry to generate a random number; transmitting the random number to a certificate authority (CA) server; receiving a signed request from the CA server to perform an open state restoration process, the signed request including the random number; in response to receiving the signed request from the CA, causing the SoC and the companion circuitry to delete their respectively stored keys, thereby restoring the SoC and the companion circuitry to the open state. Moreover, the processing circuitry is configured to forward the signed request received from the CA server to perform the open state restoration process to the SoC, and wherein the SoC is configured to delete a stored key in response to receiving the signed request. In addition or in alternative to and in any combination with the optional features previously explained in this paragraph, the SoC is configured to store the random number generated by the companion circuitry in a predetermined addressable location of the SoC. In addition or in alternative to and in any combination with the optional features previously explained in this paragraph, the processing circuitry is configured to forward the signed request received from the CA server to perform the open state restoration process to the SoC, and wherein the SoC is configured to (i) authenticate the signed request by verifying that the random number included in the signed request matches the random number stored in the predetermined addressable location of the SoC, and (ii) delete a stored key in response to authenticating the signed request. In addition or in alternative to and in any combination with the optional features previously explained in this paragraph, the SoC is configured to forward the signed request received from the CA server to perform the open state restoration process to the companion circuitry. In addition or in alternative to and in any combination with the optional features previously explained in this paragraph, the SoC is configured to store the random number in a predetermined addressable location of the SoC identified with volatile memory. In addition or in alternative to and in any combination with the optional features previously explained in this paragraph, the SoC is configured to forward the signed request received from the CA server to perform the open state restoration process to the companion circuitry, and wherein the companion circuitry is configured to (i) authenticate the signed request by verifying that the random number included in the signed request matches the random number stored in the predetermined addressable location of the companion circuitry, and (ii) delete a stored key in response to authenticating the signed request. In addition or in alternative to and in any combination with the optional features previously explained in this paragraph, the random number comprises a number only used once (nonce). In addition or in alternative to and in any combination with the optional features previously explained in this paragraph, the random number comprises a number that is identified with a predetermined number of open state restoration processes greater than one. In addition or in alternative to and in any combination with the optional features previously explained in this paragraph, the companion circuitry comprises an expansion card configured to support wireless communications.

### EXAMPLES

The following examples pertain to various techniques of the present disclosure.

An example (e.g. example 1) is directed to a system on a chip (SoC), comprising: a processing unit; and connection control circuitry configured to implement a trust on first use (TOFU) authentication scheme to establish, on an initial power up of the SoC while connected to a companion circuitry, a trust relationship with the companion circuitry by: storing a key in a predetermined addressable location of the SoC when the connection control circuitry has determined that a key is not stored in the SoC or in the companion circuitry; and transmitting the key to the companion circuitry via a data interface, wherein, upon receiving the key, the companion circuitry stores the key in a predetermined addressable location of the companion circuitry.

Another example (e.g. example 2) relates to a previously-described example (e.g. example 1), wherein the connection control circuitry is configured to transmit the key to the companion circuitry using an unencrypted transmission.

Another example (e.g. example 3) relates to a previously-described example (e.g. one or more of examples 1-2), wherein the connection control circuitry is further configured to, upon subsequent power ups of the SoC while connected to the companion circuitry, utilize the stored key to perform encrypted communications with the companion circuitry via the data interface.

Another example (e.g. example 4) relates to a previously-described example (e.g. one or more of examples 1-3), wherein the encrypted communications comprise symmetric encryption communications in which the key is used for encryption and decryption of data sent via the data interface.

Another example (e.g. example 5) relates to a previously-described example (e.g. one or more of examples 1-4), wherein the connection control circuitry is configured to generate the key via a random number generator.

Another example (e.g. example 6) relates to a previously-described example (e.g. one or more of examples 1-5), wherein the connection control circuitry is configured to store the key in a non-volatile memory.

Another example (e.g. example 7) relates to a previously-described example (e.g. one or more of examples 1-6), wherein the companion circuitry comprises an expansion card configured to support wireless communications.

An example (e.g. example 8) is directed to a system on a chip (SoC), comprising: a processing unit; and connection control circuitry configured to (i) communicate with a companion circuitry via a data interface, the SoC and companion circuitry forming part of a hardware platform associated with a predetermined hardware identifier, and (ii) upon an initial power up of the SoC while connected to the companion circuitry, execute a signed image identified with executable firmware to operate in a debugging mode of operation by: upon verifying that a hardware identifier of the signed image matches the predetermined hardware identifier, storing a preexisting key contained in the signed image; transmitting the preexisting key to the companion circuitry via the data interface; and on a subsequent power up of the SoC while connected to the companion circuitry, executing the signed image to operate in the debugging mode of operation by: verifying that the companion circuitry has stored the preexisting key; and using the preexisting key to perform encrypted communications with the companion circuitry via the data interface.

Another example (e.g. example 9) relates to a previously-described example (e.g. example 8), wherein the encrypted communications comprise symmetric encrypted communications in which the preexisting key is used for encryption and decryption of data sent via the data interface.

Another example (e.g. example 10) relates to a previously-described example (e.g. one or more of examples 8-9), wherein the SoC is configured to, upon a subsequent power up of the SoC while connected to the companion circuitry, execute the signed image to operate in the debugging mode of operation only upon verifying that the hardware identifier of the signed image matches the predetermined platform hardware identifier.

Another example (e.g. example 11) relates to a previously-described example (e.g. one or more of examples 8-10), wherein the connection control circuitry is configured to transmit the preexisting key to the companion circuitry using an unencrypted transmission.

Another example (e.g. example 12) relates to a previously-described example (e.g. one or more of examples 8-11), wherein the companion circuitry is configured to store the preexisting key in a non-volatile memory.

Another example (e.g. example 13) relates to a previously-described example (e.g. one or more of examples 8-12), wherein the companion circuitry comprises an expansion card configured to support wireless communications.

An example (e.g. example 14) is directed to an electronic device, comprising: a system on a chip (SoC) communicatively coupled to a companion circuitry; a memory configured to store computer-readable instructions; and processing circuitry configured to execute the computer-readable instructions to restore the SoC and the companion circuitry to an open state in which no key is stored on the SoC or the companion circuitry by: transmitting a request to the companion circuitry to generate a random number; transmitting the random number to a certificate authority (CA) server; receiving a signed request from the CA server to perform an open state restoration process, the signed request including the random number; in response to receiving the signed request from the CA, causing the SoC and the companion circuitry to delete their respectively stored keys, thereby restoring the SoC and the companion circuitry to the open state.

Another example (e.g. example 15) relates to a previously-described example (e.g. example 14), wherein the processing circuitry is configured to forward the signed request received from the CA server to perform the open state restoration process to the SoC, and wherein the SoC is configured to delete a stored key in response to receiving the signed request.

Another example (e.g. example 16) relates to a previously-described example (e.g. one or more of examples 14-15), wherein the SoC is configured to store the random number generated by the companion circuitry in a predetermined addressable location of the SoC.

Another example (e.g. example 17) relates to a previously-described example (e.g. one or more of examples 14-16), wherein the processing circuitry is configured to forward the signed request received from the CA server to perform the open state restoration process to the SoC, and wherein the SoC is configured to (i) authenticate the signed request by verifying that the random number included in the signed request matches the random number stored in the predetermined addressable location of the SoC, and (ii) delete a stored key in response to authenticating the signed request.

Another example (e.g. example 18) relates to a previously-described example (e.g. one or more of examples 14-17), wherein the SoC is configured to forward the signed request received from the CA server to perform the open state restoration process to the companion circuitry.

Another example (e.g. example 19) relates to a previously-described example (e.g. one or more of examples 14-18), wherein the SoC is configured to store the random number in a predetermined addressable location of the SoC identified with volatile memory.

Another example (e.g. example 20) relates to a previously-described example (e.g. one or more of examples 14-19), wherein the SoC is configured to forward the signed request received from the CA server to perform the open state restoration process to the companion circuitry, and wherein the companion circuitry is configured to (i) authenticate the signed request by verifying that the random number included in the signed request matches the random number stored in the predetermined addressable location of the companion circuitry, and (ii) delete a stored key in response to authenticating the signed request.

Another example (e.g. example 21) relates to a previously-described example (e.g. one or more of examples 14-20), wherein the random number comprises a number only used once (nonce).

Another example (e.g. example 22) relates to a previously-described example (e.g. one or more of examples 14-21), wherein the random number comprises a number that is identified with a predetermined number of open state restoration processes greater than one.

Another example (e.g. example 23) relates to a previously-described example (e.g. one or more of examples 14-22), wherein the companion circuitry comprises an expansion card configured to support wireless communications.

An example (e.g. example 24) is directed to a system on a chip (SoC), comprising: a processing means; and connection control means for implementing a trust on first use (TOFU) authentication scheme to establish, on an initial power up of the SoC while connected to a companion circuitry, a trust relationship with the companion circuitry by: storing a key in a predetermined addressable location of the SoC when the connection control means has determined that a key is not stored in the SoC or in the companion circuitry; and transmitting the key to the companion circuitry via a data interface, wherein, upon receiving the key, the companion circuitry stores the key in a predetermined addressable location of the companion circuitry.

Another example (e.g. example 25) relates to a previously-described example (e.g. example 24), wherein the connection control means transmits the key to the companion circuitry using an unencrypted transmission.

Another example (e.g. example 26) relates to a previously-described example (e.g. one or more of examples 24-25), wherein the connection control means further, upon subsequent power ups of the SoC while connected to the companion circuitry, utilizes the stored key to perform encrypted communications with the companion circuitry via the data interface.

Another example (e.g. example 27) relates to a previously-described example (e.g. one or more of examples 24-26), wherein the encrypted communications comprise symmetric encryption communications in which the key is used for encryption and decryption of data sent via the data interface.

Another example (e.g. example 28) relates to a previously-described example (e.g. one or more of examples 24-27), wherein the connection control means generates the key via a random number generator.

Another example (e.g. example 29) relates to a previously-described example (e.g. one or more of examples 24-28), wherein the connection control means stores the key in a non-volatile memory.

Another example (e.g. example 30) relates to a previously-described example (e.g. one or more of examples 24-29), wherein the companion circuitry comprises an expansion card configured to support wireless communications.

An example (e.g. example 31) is directed to a system on a chip (SoC), comprising: a processing means; and connection control means for (i) communicating with a companion circuitry via a data interface, the SoC and companion circuitry forming part of a hardware platform associated with a predetermined hardware identifier, and (ii) upon an initial power up of the SoC while connected to the companion circuitry, executing a signed image identified with executable firmware to operate in a debugging mode of operation by: upon verifying that a hardware identifier of the signed image matches the predetermined hardware identifier, storing a preexisting key contained in the signed image; transmitting the preexisting key to the companion circuitry via the data interface; and on a subsequent power up of the SoC while connected to the companion circuitry, executing the signed image to operate in the debugging mode of operation by: verifying that the companion circuitry has stored the preexisting key; and using the preexisting key to perform encrypted communications with the companion circuitry via the data interface.

Another example (e.g. example 32) relates to a previously-described example (e.g. example 31), wherein the encrypted communications comprise symmetric encrypted communications in which the preexisting key is used for encryption and decryption of data sent via the data interface.

Another example (e.g. example 33) relates to a previously-described example (e.g. one or more of examples 31-32), wherein the SoC is configured to, upon a subsequent power up of the SoC while connected to the companion circuitry, execute the signed image to operate in the debugging mode of operation only upon verifying that the hardware identifier of the signed image matches the predetermined platform hardware identifier.

Another example (e.g. example 34) relates to a previously-described example (e.g. one or more of examples 31-33), wherein the connection control means transmits the preexisting key to the companion circuitry using an unencrypted transmission.

Another example (e.g. example 35) relates to a previously-described example (e.g. one or more of examples 31-34), wherein the companion circuitry is configured to store the preexisting key in a non-volatile memory.

Another example (e.g. example 36) relates to a previously-described example (e.g. one or more of examples 31-35), wherein the companion circuitry comprises an expansion card configured to support wireless communications.

An example (e.g. example 37) is directed to an electronic device, comprising: a system on a chip (SoC) communicatively coupled to a companion circuitry; a memory configured to store computer-readable instructions; and processing means for executing the computer-readable instructions to restore the SoC and the companion circuitry to an open state in which no key is stored on the SoC or the companion circuitry by: transmitting a request to the companion circuitry to generate a random number; transmitting the random number to a certificate authority (CA) server; receiving a signed request from the CA server to perform an open state restoration process, the signed request including the random number; in response to receiving the signed request from the CA, causing the SoC and the companion circuitry to delete their respectively stored keys, thereby restoring the SoC and the companion circuitry to the open state.

Another example (e.g. example 38) relates to a previously-described example (e.g. example 37), wherein the processing means forwards the signed request received from the CA server to perform the open state restoration process to the SoC, and wherein the SoC is configured to delete a stored key in response to receiving the signed request.

Another example (e.g. example 39) relates to a previously-described example (e.g. one or more of examples 37-38), wherein the SoC is configured to store the random number generated by the companion circuitry in a predetermined addressable location of the SoC.

Another example (e.g. example 40) relates to a previously-described example (e.g. one or more of examples 37-39), wherein the processing means forwards the signed request received from the CA server to perform the open state restoration process to the SoC, and wherein the SoC is configured to (i) authenticate the signed request by verifying that the random number included in the signed request matches the random number stored in the predetermined addressable location of the SoC, and (ii) delete a stored key in response to authenticating the signed request.

Another example (e.g. example 41) relates to a previously-described example (e.g. one or more of examples 37-40), wherein the SoC is configured to forward the signed request received from the CA server to perform the open state restoration process to the companion circuitry.

Another example (e.g. example 42) relates to a previously-described example (e.g. one or more of examples 37-41), wherein the SoC is configured to store the random number in a predetermined addressable location of the SoC identified with volatile memory.

Another example (e.g. example 43) relates to a previously-described example (e.g. one or more of examples 37-42), wherein the SoC is configured to forward the signed request received from the CA server to perform the open state restoration process to the companion circuitry, and wherein the companion circuitry is configured to (i) authenticate the signed request by verifying that the random number included in the signed request matches the random number stored in the predetermined addressable location of the companion circuitry, and (ii) delete a stored key in response to authenticating the signed request.

Another example (e.g. example 44) relates to a previously-described example (e.g. one or more of examples 37-43), wherein the random number comprises a number only used once (nonce).

Another example (e.g. example 45) relates to a previously-described example (e.g. one or more of examples 37-44), wherein the random number comprises a number that is identified with a predetermined number of open state restoration processes greater than one.

Another example (e.g. example 46) relates to a previously-described example (e.g. one or more of examples 37-45), wherein the companion circuitry comprises an expansion card configured to support wireless communications.

An apparatus as shown and described.

A method as shown and described.

### CONCLUSION

The aforementioned description will so fully reveal the general nature of the disclosure that others can, by applying knowledge within the skill of the art, readily modify and/or adapt for various applications without undue experimentation, and without departing from the general concept of the present disclosure. Therefore, such adaptations and modifications are intended to be within the meaning and range of equivalents of the disclosed implementations, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

It is noted that the aforementioned implementations are provided as non-limiting and illustrative scenarios, which may encompass various specific use cases. The implementations as discussed herein may deviate from those discussed herein, with some functions and/or implementations being optional in some scenarios. For instance, a “lighter” version of the interface as discussed herein may be utilized, which is more cost effective.

References in the specification to “one implementation,” “an implementation,” “an exemplary implementation,” etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, it is submitted that it is within the knowledge of one skilled in the art to affect such feature, structure, or characteristic in connection with other implementations whether or not explicitly described.

The implementations described herein are provided for illustrative purposes, and are not limiting. Other implementations are possible, and modifications may be made to the described implementations. Therefore, the specification is not meant to limit the disclosure. Rather, the scope of the disclosure is defined only in accordance with the following claims and their equivalents.

The implementations described herein may be facilitated in hardware (e.g., circuits), firmware, software, or any combination thereof. Implementations may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact results from computing devices, processors, controllers, or other devices executing the firmware, software, routines, instructions, etc. Further, any of the implementation variations may be carried out by a general purpose computer.

For the purposes of this discussion, the term “processing circuitry” or “processor circuitry” shall be understood to be circuit(s), processor(s), logic, or a combination thereof. For example, a circuit can include an analog circuit, a digital circuit, state machine logic, other structural electronic hardware, or a combination thereof. A processor can include a microprocessor, a digital signal processor (DSP), or other hardware processor. The processor can be “hard-coded” with instructions to perform corresponding function(s) according to implementations described herein. Alternatively, the processor can access an internal and/or external memory to retrieve instructions stored in the memory, which when executed by the processor, perform the corresponding function(s) associated with the processor, and/or one or more functions and/or operations related to the operation of a component having the processor included therein.

In one or more of the implementations described herein, processing circuitry can include memory that stores data and/or instructions. The memory can be any well-known volatile and/or non-volatile memory, including, for example, read-only memory (ROM), random access memory (RAM), flash memory, a magnetic storage media, an optical disc, erasable programmable read only memory (EPROM), and programmable read only memory (PROM). The memory can be non-removable, removable, or a combination of both.

What is claimed is:

1. A system on a chip (SoC), comprising:
a processing unit; and
connection control circuitry configured to implement a trust on first use (TOFU) authentication scheme to establish, on an initial power up of the SoC while connected to a companion circuitry, a trust relationship with the companion circuitry by:
storing a key in a predetermined addressable location of the SoC when the connection control circuitry has determined that a key is not stored in the SoC or in the companion circuitry; and
transmitting the key to the companion circuitry via a data interface,
wherein, upon receiving the key, the companion circuitry stores the key in a predetermined addressable location of the companion circuitry.

2. The SoC of claim 1, wherein the connection control circuitry is configured to transmit the key to the companion circuitry using an unencrypted transmission.

3. The SoC of claim 1, wherein the connection control circuitry is further configured to, upon subsequent power ups of the SoC while connected to the companion circuitry, utilize the stored key to perform encrypted communications with the companion circuitry via the data interface.

4. The SoC of claim 3, wherein the encrypted communications comprise symmetric encryption communications in which the key is used for encryption and decryption of data sent via the data interface.

5. The SoC of claim 1, wherein the connection control circuitry is configured to generate the key via a random number generator.

6. The SoC of claim 1, wherein the connection control circuitry is configured to store the key in a non-volatile memory.

7. The SoC of claim 1, wherein the companion circuitry comprises an expansion card configured to support wireless communications.

8. A system on a chip (SoC), comprising:
a processing unit; and
connection control circuitry configured to (i) communicate with a companion circuitry via a data interface, the SoC and companion circuitry forming part of a hardware platform associated with a predetermined hardware identifier, and (ii) upon an initial power up of the SoC while connected to the companion circuitry, execute a signed image identified with executable firmware to operate in a debugging mode of operation by:
upon verifying that a hardware identifier of the signed image matches the predetermined hardware identifier, storing a preexisting key contained in the signed image;
transmitting the preexisting key to the companion circuitry via the data interface; and
on a subsequent power up of the SoC while connected to the companion circuitry, executing the signed image to operate in the debugging mode of operation by:
verifying that the companion circuitry has stored the preexisting key; and
using the preexisting key to perform encrypted communications with the companion circuitry via the data interface.

9. The SoC of claim 8, wherein the encrypted communications comprise symmetric encrypted communications in which the preexisting key is used for encryption and decryption of data sent via the data interface.

10. The SoC of claim 8, wherein the SoC is configured to, upon a subsequent power up of the SoC while connected to the companion circuitry, execute the signed image to operate in the debugging mode of operation only upon verifying that the hardware identifier of the signed image matches the predetermined platform hardware identifier.

11. The SoC of claim 8, wherein the connection control circuitry is configured to transmit the preexisting key to the companion circuitry using an unencrypted transmission.

12. The SoC of claim 8, wherein the companion circuitry is configured to store the preexisting key in a non-volatile memory.

13. The SoC of claim 8, wherein the companion circuitry comprises an expansion card configured to support wireless communications.

14. An electronic device, comprising:
a system on a chip (SoC) communicatively coupled to a companion circuitry;
a memory configured to store computer-readable instructions; and
processing circuitry configured to execute the computer-readable instructions to restore the SoC and the companion circuitry to an open state in which no key is stored on the SoC or the companion circuitry by:
transmitting a request to the companion circuitry to generate a random number;
transmitting the random number to a certificate authority (CA) server;
receiving a signed request from the CA server to perform an open state restoration process, the signed request including the random number;
in response to receiving the signed request from the CA, causing the SoC and the companion circuitry to delete their respectively stored keys, thereby restoring the SoC and the companion circuitry to the open state.

15. The electronic device of claim 14, wherein the processing circuitry is configured to forward the signed request received from the CA server to perform the open state restoration process to the SoC, and
wherein the SoC is configured to delete a stored key in response to receiving the signed request.

16. The electronic device of claim 14, wherein the SoC is configured to store the random number generated by the companion circuitry in a predetermined addressable location of the SoC.

17. The electronic device of claim 15, wherein the processing circuitry is configured to forward the signed request received from the CA server to perform the open state restoration process to the SoC, and
wherein the SoC is configured to (i) authenticate the signed request by verifying that the random number included in the signed request matches the random number stored in the predetermined addressable location of the SoC, and (ii) delete the stored key in response to authenticating the signed request.

18. The electronic device of claim 14, wherein the SoC is configured to forward the signed request received from the CA server to perform the open state restoration process to the companion circuitry.

19. The electronic device of claim 14, wherein the SoC is configured to store the random number in a predetermined addressable location of the SoC identified with volatile memory.

20. The electronic device of claim 19, wherein the SoC is configured to forward the signed request received from the CA server to perform the open state restoration process to the companion circuitry, and
wherein the companion circuitry is configured to (i) authenticate the signed request by verifying that the random number included in the signed request matches the random number stored in the predetermined addressable location of the companion circuitry, and (ii) delete a stored key in response to authenticating the signed request.

21. The electronic device of claim 14, wherein the random number comprises a number only used once (nonce).

22. The electronic device of claim 14, wherein the random number comprises a number that is identified with a predetermined number of open state restoration processes greater than one.

23. The electronic device of claim 14, wherein the companion circuitry comprises an expansion card configured to support wireless communications.
